(19) United States
(12) Patent Application Publication
(10) Pub. No.: US 2005/0198031 A1
(43) Pub. Date: Sep. 8, 2005

(54) Method and system for controlling access to user information in a social networking environment

(76) Inventors: Peter Pezaris, Delray Beach, FL (US); Michael Gersh, Delray Beach, FL (US)

Correspondence Address: PEPPER HAMILTON LLP, ONE MELLON CENTER, 50TH FLOOR, 500 GRANT STREET, PITTSBURGH, PA, 15219, US

(21) Appl. No.: 10/793,233

(22) Filed: Mar. 4, 2004

(51) Int. Cl. G06F 17/30

(52) U.S. Cl. 707/9

(57) ABSTRACT

Methods and systems for controlling access to content in a social networking environment are disclosed. A first user defines relationships with a plurality of second users by assigning one or more relationship designators for each relationship. The first user stores content within the social networking environment and denotes individuals allowed to or prevented from accessing the content by entering one or more relationship designators. The first user may further control access by using tier designators. The social networking environment may generate a proximity index based on the relationships between a first user and a particular second user. The first user may control access to content based on the proximity index. The first user may also allow or prevent the reception of content from other users having particular relationship designators, tier designators, and/or proximity indices with respect to the first user.

### TECHNICAL FIELD

The present invention generally relates to methods and systems for creating social networking environments. Specifically, the invention relates to controlling access to information in a social networking environment based on user-defined and/or system-generated parameters.

### BACKGROUND

Individuals form social networks of other individuals for a variety of reasons. Most people develop personal networks that include friends, acquaintances, and the like as a means of obtaining social interaction. In addition, people develop professional networks that include co-workers, managers, vendors, clients and the like as a means of enhancing their professional life. A person may use his personal or professional networks (individually or collectively, a person's social network) to, for example, obtain dates, enhance job searches or form a guest list for an event.

A person may attempt to expand his social network by attending social functions or conferences in order to meet new people, by requesting that someone within the person's social network introduce the person to someone outside of the person's social network, or by simply meeting someone on the street. Generally, such expansions of a person's social network require that the two people physically come in contact or at least that the two coordinate to engage in conversation at the same time. Hence, such social network expansion may be time-intensive and require substantive effort on the part of the person seeking to expand his social network.

The introduction of the Internet has provided an additional medium for expanding one's social network. Chat rooms, message boards, and interactive Web sites each provide the opportunity for people to meet other people and expand their social networks. Moreover, information may be transmitted from one person to another over the Internet by posting the information on a Web site or by sending an e-mail message to another person's e-mail address. Because the Internet allows users to interact with individuals that are remotely located, the Internet can provide a powerful tool in expanding one's social network.

In addition, Internet users need not be online at the same time in order to share information or develop a personal contact. For example, one user may send an e-mail message to a second user while the second user is not present at his computer. Despite being remotely located and not being online at the same time, the information may still be transmitted to the second individual.

Accordingly, computers and the Internet have increasingly become tools that allow people to interact with one another and to meet new people. E-dating Web sites, social networking Web sites, which are either social or professional in nature, and other similar services have been developed to meet this need.

One problem with these services is that information is generally made publicly available to either an unspecified or a restricted number of people. For example, if an individual posts a message regarding an event on a Web site that is publicly available, anyone accessing the Web site may learn of the event, even if the organizer did not intend to invite everyone with access to the Web site.

Conversely, the individual may send an e-mail regarding the event to a distribution list. However, if the organizer intends to permit people who are unknown to the organizer but are acquainted with those on the distribution list to attend, those initially receiving the message must forward the information. As such, proper dispersal of information to all invited parties is dependent upon the recipients of the message and may not occur for a variety of reasons.

Social networking Web sites have been developed to provide some control over the distribution of content within a social network. A user may enter the names of one or more individuals into the social networking Web site. The site may generate a connection between the user and each individual immediately or may wait until a response has been received from an individual before creating a connection between the user and the responding individual.

Conventional social networking Web sites have addressed the issue of access control by defining relationships to be in tiers. For example, all people directly connected to a particular user are said to be in the user's first tier. The second tier is composed of all users that are first tier connections to individuals who are in the user's first tier, and so on. In theory, no more than six tiers would separate each user from any other user if the network included a substantial subset of the people in the world.

One problem with conventional social networking Web sites is that the tier method of access control may simultaneously be overly inclusive and exclusive. For example, if a user desires to send information to individuals in a subset of the user's first tier and individuals in a subset of the user's second tier, sending the information only to the first tier would prevent the individuals in the user's second tier from receiving the information. Moreover, too many individuals in the user's first tier would receive the information. Accordingly, using the tier system alone does not provide adequate access control in a social networking environment in at least circumstances similar to the one described.

What is needed is a method and system for appropriately controlling access to user information in a social networking environment.

A further need exists for controlling access to user information in a social networking environment by using user-defined parameters.

A still further need exists for controlling access to user information in a social networking environment by using parameters generated by the social networking environment.

The present invention is directed towards solving one or more of these problems.

### SUMMARY OF THE INVENTION

Before the present methods, systems, and materials are described, it is to be understood that this invention is not limited to the particular methodologies, systems and materials described, as these may vary. It is also to be understood that the terminology used in the description is for the purpose of describing the particular versions or embodiments only, and is not intended to limit the scope of the present invention which will be limited only by the appended claims.

It must also be noted that as used herein and in the appended claims, the singular forms “a,” “an,” and “the” include plural references unless the context clearly dictates otherwise. Thus, for example, reference to a “social network” is a reference to one or more social networks and equivalents thereof known to those skilled in the art, and so forth. Unless defined otherwise, all technical and scientific terms used herein have the same meanings as commonly understood by one of ordinary skill in the art. Although any methods, materials, and devices similar or equivalent to those described herein can be used in the practice or testing of embodiments of the present invention, the preferred methods, materials, and devices are now described. All publications mentioned herein are incorporated by reference. Nothing herein is to be construed as an admission that the invention is not entitled to antedate such disclosure by virtue of prior invention.

In an embodiment, a method of controlling access to content in a social networking environment includes receiving, from a first user, an access control criterion for content of the first user, and permitting the second user to access the content of the first user if relationship information for a second user corresponds to the access control criterion. The access control criterion includes a first relationship designator. The relationship information includes a second relationship designator. In an embodiment, the method further includes preventing the second user from accessing the content of the first user if the relationship information for the second user does not correspond to the access control criterion. The first relationship designator may include one or more of a familial relationship designator, a friendship relationship designator, a co-worker relationship designator, and a business associate relationship designator. The access control criterion may further include a tier designator. The second relationship designator may include one or more of a familial relationship designator, a friendship relationship designator, a co-worker relationship designator, and a business associate relationship designator. The relationship information may further include a tier designator. In an embodiment, permitting the second user to access content of the first user may include displaying the content of the first user and/or displaying a link to the content of the first user. In an embodiment, preventing the second user from accessing content of the first user may include not displaying the content of the first user when displaying a web page and/or not displaying a link to the content of the first user when displaying a web page.

In an embodiment, a method of controlling access to content in a social networking environment includes receiving, from a first user, an access control criterion for content directed to the first user, and permitting the first user to access content directed to the first user from the second user if relationship information for a second user corresponds to the access control criterion. The access control criterion includes a first relationship designator. The relationship information includes a second relationship designator. In an embodiment, the method may further include preventing the first user from accessing content directed to the first user from the second user if the relationship information for the second user does not correspond to the access control criterion. The first relationship designator may include one or more a familial relationship designator, a friendship relationship designator, a co-worker relationship designator, and a business associate relationship designator. The access control criterion may further include a tier designator. The second relationship designator may include one or more of a familial relationship designator, a friendship relationship designator, a co-worker relationship designator, and a business associate relationship designator. The relationship information may further include a tier designator. In an embodiment, permitting the second user to access content of the first user may include displaying the content of the first user and/or displaying a link to the content of the first user. In an embodiment, preventing the second user from accessing content of the first user may include not displaying the content of the first user when displaying a web page and/or not displaying a link to the content of the first user when displaying a web page.

In an embodiment, a method of controlling access to content in a social networking environment includes assigning a value to content by a first user, generating, by a social networking environment, a proximity index denoting a strength of a relationship between the first user of the social networking environment and a second user of the social networking environment, and permitting the second user to access content of the first user if the proximity index is greater than the value. In an embodiment, generating the proximity index includes determining one or more relationships between the first user and the second user, assigning one or more relationship values, and assigning the proximity index based on the one or more relationship values. Each relationship value is based on the strength of one of the one or more relationships. In an embodiment, determining one or more relationships between the first user and the second user includes determining a first relationship between the first user and a third user, and determining a second relationship between the third user and the second user. In an embodiment, determining one or more relationships between the first user and the second user includes determining a number of paths between the first user and the second user. The strength of a relationship may be based on one or more of a number of intermediate users through which the relationship between the first user and the second user is established, and a relationship type between each pair of users used to form the relationship between the first user and the second user. The proximity index may include a designator selected from one or more of Very Close, Close, Distant, and No Contact. The proximity index may include a numerical value. The proximity index may include a number between 0 and 1, inclusive.

In an embodiment, a system for controlling access to content in a social networking environment includes a processor, a computer-readable storage medium operably connected to the processor, a communications network operably connected to the processor, and a plurality of computer systems operably connected to the communications network. The computer-readable storage medium may contain one or more programming instructions for performing a method of controlling access to content in a social networking environment including receiving, by the processor, content from a first computer system via the communications network, storing the content in the computer-readable storage medium, receiving, by the processor, access control criterion via the communications network, storing the access control criterion in the computer-readable storage medium, receiving, by the processor, access request information via the communications network, and transmitting the content to the second computer system if the access request information corresponds to the access control criterion. The content pertains to a first user. The access control criterion pertains to the content and includes a first relationship designator. The access request information is received from a second user using a second computer system and includes a second relationship designator. The access control criterion may further include a tier designator. The access request information may further include a tier designator.

In an embodiment, the computer-readable storage medium may contain one or more programming instructions for performing a method of controlling access to content in a social networking environment including receiving, by the processor, access control criterion from a first computer system via the communications network, storing the access control criterion in the computer-readable storage medium, receiving, by the processor, content via the communications network, storing the content in the computer-readable storage medium, determining a relationship between the first user and the second user, and transmitting the content to the first user at the first computer system via the communications network if the relationship corresponds to the access control criterion. The access control criterion pertains to a first user. The content is received from a second user using a second computer system. The relationship comprises a relationship designator.

In an embodiment, the computer-readable storage medium may contain one or more programming instructions for performing a method of controlling access to content in a social networking environment including receiving, by the processor, content from a first computer system via the communications network, storing the content in the computer-readable storage medium, receiving, by the processor, access control criterion via the communications network, storing the access control information in the computer-readable storage medium, receiving, by the processor, access request information via the communications network, computing a proximity index between the first user and the second user, and transmitting the content to the second computer system via the communications network if the proximity index exceeds the proximity index threshold. The content pertains to a first user. The access control criterion pertains to the content received from the first user and includes a proximity index threshold. The access request information pertains to the content and is received from a second user using a second computer system.

### BRIEF DESCRIPTION OF THE DRAWINGS

The accompanying drawings, which are incorporated in and form a part of the specification, illustrate embodiments of the present invention and, together with the description serve to explain the principles of the invention. The embodiments illustrated in the drawings should not be read to constitute limiting requirements, but instead are intended to assist the reader in understanding the invention.

FIG. 1 depicts a screen shot of an exemplary invitation screen for assigning one or more relationship designators to an invitee according to an embodiment of the present invention.

FIG. 2 depicts a screen shot of an exemplary group creation screen for creating a group according to an embodiment of the present invention.

FIG. 3 depicts a screen shot of exemplary global access control criteria according to an embodiment of the present invention.

FIG. 4 depicts a screen shot of an exemplary embodiment of the present invention using a physical distance search criterion.

FIG. 5 depicts a screen shot of exemplary access control criteria according to an embodiment of the present invention.

FIG. 6 depicts a screen shot of an exemplary content list including multi-tiered relationship designators denoting the creator of each content item according to an embodiment of the present invention.

FIG. 7 depicts a screen shot of an exemplary access control criteria for contact information according to an embodiment of the present invention.

FIG. 8 depicts a screen shot of an exemplary access control criteria for photo content according to an embodiment of the present invention.

FIG. 9 depicts a screen shot of an exemplary access control criteria for review content according to an embodiment of the present invention.

FIG. 10 depicts a screen shot of an exemplary access control criteria for journal content according to an embodiment of the present invention.

FIG. 11 depicts a screen shot of an exemplary access control criteria for calendar content according to an embodiment of the present invention.

FIG. 12 depicts a screen shot of an exemplary access control criteria for marketplace content according to an embodiment of the present invention.

FIG. 13 depicts a screen shot of an exemplary creation screen for poll content according to an embodiment of the present invention.

FIG. 14 is a block diagram of exemplary internal hardware that may be used to contain or implement the program instructions of a system embodiment of the present invention.

### DETAILED DESCRIPTION

The present invention generally relates to methods and systems for creating social networking environments. Specifically, the invention relates to controlling access to information in a social networking environment based on user-defined and/or system-generated parameters.

In an embodiment, a user may define one or more relationship designators to define the relationship between the user and a contact. In an embodiment, the social networking environment may generate a proximity index and/or a tier level to define the relationship between two users. In an embodiment, the social networking environment may determine a physical distance between two users based on, for example, the users' zip codes or street addresses. A social networking environment may use these, additional or alternate user-defined and system-generated parameters to define relationships between one or more users. The exemplary user-defined and system-generated parameters are described below.

Relationship Designators

User defined parameters for access control in a social networking environment may include providing a relationship designator defining the relationship between an individual and a contact (i.e., a first tier individual in conventional social networking environments). Relationship designations may include one or more of familial relationship designators, friendship relationship designators, co-worker relationship designators and business associate relationship designators. Familial relationship designators may include wife, husband, mother, father, mother-in-law, father-in-law, daughter, son, daughter-in-law, son-in-law, sister, brother, sister-in-law, brother-in-law, grandmother, grandfather, grandson, granddaughter, cousin, second cousin, aunt, uncle, nephew, niece, stepmother, stepfather, stepsister, stepbrother, stepson, stepdaughter, ex-wife, ex-husband, friend of the family, distant relative, other relative and life partner. Friendship relationship designators may include fiancé, girlfriend, boyfriend, friend, roommate, neighbor, sorority sister, fraternity brother and classmate. Co-worker relationship designators may include co-worker, manager, employee and business partner. Business associate relationship designators may include vendor, supplier, client, contractor and business contact. In an embodiment, additional or alternate relationship designators may be used for a social networking environment. In an embodiment, alternate or additional categories of relationship designators may be used. In an embodiment, relationship designators may be grouped in different categories.

In an embodiment, a relationship between two individuals may include more than one relationship designator. For example, a user may be each of a friend, a fraternity brother, a classmate and a business partner of another user. In such an embodiment, the present invention may permit a user to enter a plurality of relationship designations to appropriately describe the relationship between the user and an individual. The social networking environment may require the individual to confirm each relationship designator separately in order to accurately describe the relationship between the user and the individual.

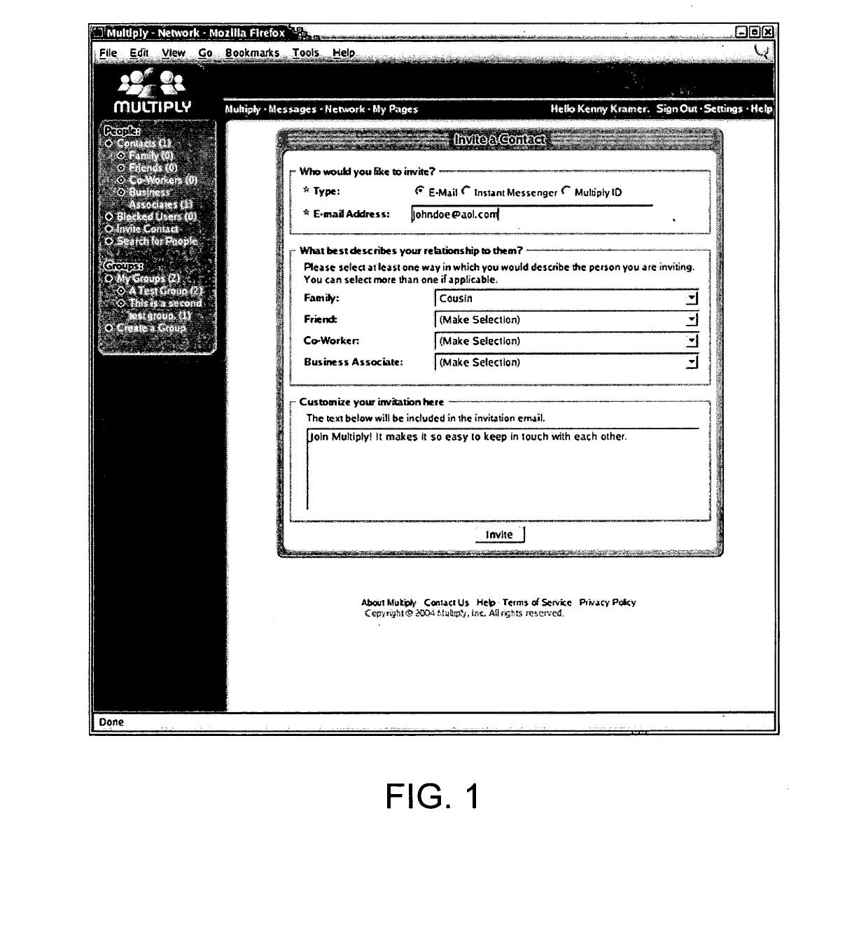

In an embodiment, the user assigns one or more relationship designators to an individual when the individual is added as a contact, as shown in FIG. 1. The individual may receive a message from the social networking environment stating that the user would like to add the individual as a contact. In an embodiment, the social networking environment may automatically assign a second relationship designator based upon the first relationship designator assigned by the user to the individual and the genders of each of the user and the individual For example, a male user may assign a relationship designator of “girlfriend” to a female contact. Upon acceptance of the contact relationship by the female contact, the social networking environment may automatically assign a relationship designator of “boyfriend” to the male user in the female contact's social network. In an embodiment, the social networking environment automatically assigns corresponding relationship designators for a subset of all relationship designator types, such as familial relationships. In an embodiment, the social networking environment may permit an individual to assign his or her own relationship designators to a contacting user when accepting an invitation to form a relationship or after such acceptance.

In the case where the individual to which the user assigns one or more relationship designators is not a user of a social networking environment, the individual may be required to become a user before the individual is added as a contact of the first user. In the case where the individual is already a user of the social networking environment, the environment may associate the user with the individual upon receipt of the individual's response to the user's request.

A user may combine a relationship designator with a tier designator (described below) to control access to user-specified content within a social networking environment. For example, the user may state that the content is available to all “second tier friends.” In an embodiment, the designation “second tier friends” may make content available to the friends of each of the user's contacts. In an alternate embodiment, the designation “second tier friends”, may make content available to friends of each of the user's friends. Additional designations and/or more particular designations may be made using embodiments of the present invention.

Group Designators

User defined parameters for access control in a social networking environment may further include a group designator of which one or more users are members of a group associated with the group designator. In an embodiment, group designators are a subset of relationship designators. A group designator may operate as a user-defined relationship designator.

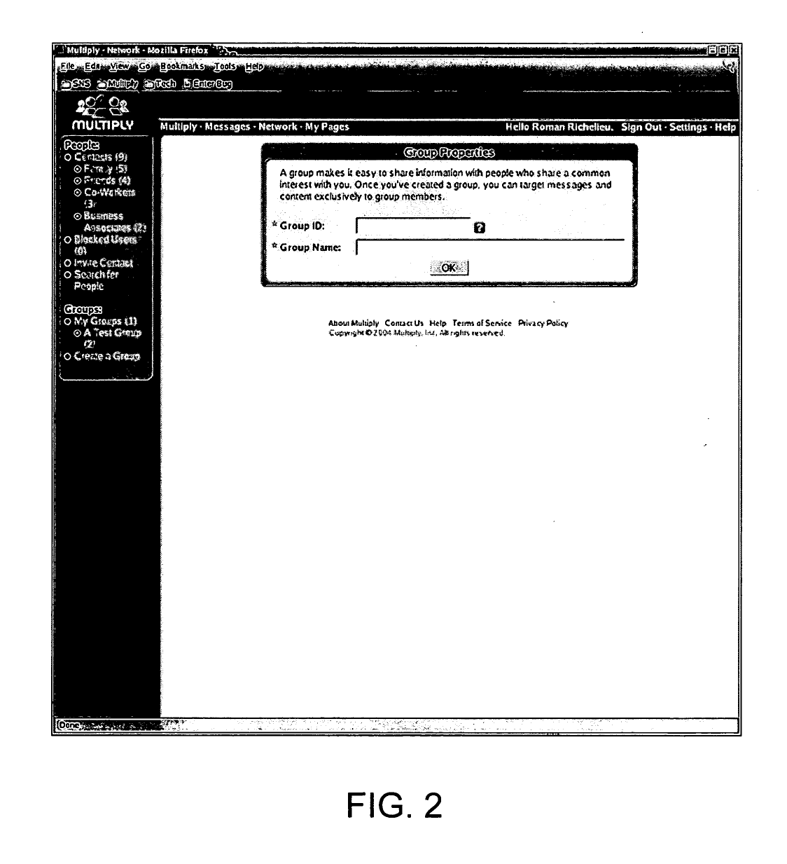

A user may create a group in a social networking environment, assign a group designator to the group and invite other users to become members of the group. A user that controls the operation of the group is referred to as the “manager.” Other users in the group are referred to herein as “members.” The manager is typically also a member. Users who have been invited to join the group are referred to herein as “pending members.” An exemplary group creation screen according to an embodiment of the present invention is depicted in FIG. 2.

In an embodiment, the manager creates the group by, for example, clicking on a link to create a new group and assigning a group name to the group. Assigning the group name may further include assigning a group identifier. Once created, the manager may invite other users to become members of the group. A message may be transmitted to the pending members alerting them that the manager has requested their acceptance of group membership. Pending members may then accept or deny membership in the group. Upon acceptance, members may further invite other users to join the group.

Group members may interact within the social networking environment by sending messages or posting content to other group members. Groups may be created for any purpose. Exemplary groups include, without limitation, scout troops, airplane enthusiasts, fraternity brothers, fans of a musical group and the like.

A user may combine a group designator with a tier designator (described below) to control access to user-specified content within a social networking environment. For example, the user may state that the content is available to “my airplane enthusiast club's family.” In an embodiment, the designation “my airplane enthusiast club's family” may make content available to the family members of each member of the airplane enthusiast club. Additional designations and/or more particular designations may be made using embodiments of the present invention.

Proximity Index

A social networking environment may determine proximity index values between users of the environment. A proximity index value measures the closeness of the relationship between two users of the environment.

Proximity indices may permit a user to manage control to his content by appropriately presenting content to the proper audience. Indeed, by properly assigning an audience proximity index, the user makes the content inherently more valuable. For example, a user may be more interested in purchasing items from a person known to them or known by a friend than from a stranger. Moreover, a review of a restaurant from a newspaper or periodical may be less interesting than a review from someone that the user knows.

A user may use a system-generated proximity index as a parameter to determine the individuals that receive specific content from the user. The user may set a proximity index threshold for all content created by the user, all content of a particular type, or particular content.

In an embodiment, the social networking environment may generate the proximity index from one or more of the following pieces of information:
The number of tiers or degrees separating the individuals
The number of distinct paths between two individuals (e.g., a first user may be the wife of a second user and a friend to a third user, where the second and third users are friends of a fourth user and where the proximity is generated from the first user to the fourth user)
The relationship type between two individuals (e.g., wife/husband vs. cousin/cousin)
The number of relationship types between two individuals (e.g., a first user may be both a friend and a co-worker of a second user)
Whether the individuals share membership in the same group, taking into account, for example, a group type (e.g., public or private) and the size of the group
Whether actual communication has occurred between the two individuals
Whether actual communication has occurred between shared contacts of the two individuals

Other or additional information may be used to compute the proximity index.

The proximity index may be, for example, a numerical value between 0 and 1, inclusive. In an embodiment, a proximity index of 1 may represent the relationship of a user to himself and may not be achievable between two distinct users.

The social networking environment may map ranges of numerical proximity index values to user-discernable labels. In an embodiment, a numerical proximity index between 0.800 and 0.999 may map to a proximity index label of “Very Close;” a numerical proximity index between 0.600 and 0.799 may map to a proximity index label of “Close;” and a numerical proximity index between 0.400 and 0.599 may map to a proximity index label of “Distant.” In an embodiment, a numerical proximity index less than 0.400 may not receive a proximity index label because the relationship between the two users is too tenuous. The above-listed numerical ranges and proximity index labels are exemplary only. Any numerical range, number of proximity index labels and/or proximity index label designators may be used for the proximity index labels.

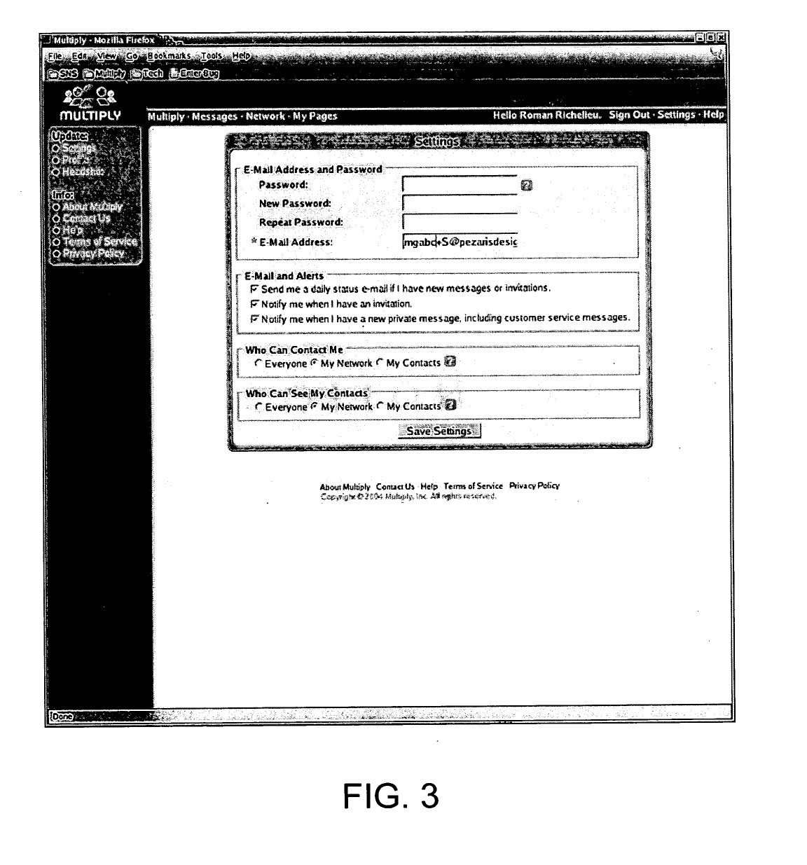

The social networking environment may use the labels and associated icons to enable users to quickly modify settings and identify the proximity of other users. For example, an icon may be included in each row of a table containing messages or items for sale in a marketplace. A user may elect to filter his messages based on the proximity of the sender to the user, such as only viewing messages from people in the user's social network who are “Very Close” or “Close.” In an embodiment, the user may globally set these settings in a Settings page, as shown in FIG. 3.

Tier Designators

A tier designator may represent the shortest distance between two individuals. For example, if a first user is a friend of a second user, who is the wife of a third user, who is a co-worker of a fourth user, then the first user is in the third tier of the fourth user's social network. Likewise, the fourth user is in the third tier of the first user's social network. If the first user is additionally the manager of a fifth user, who is a friend of the fourth user, then the first user and the fourth user would each be in the second tier of the other user's social network.

Tier designators provide one measure used in determining the proximity index. In addition, tier designators may be combined with one or more relationship designators to define access control for a user's content. For example, a user may permit “second tier friends” to access content displayed by the user. In an embodiment, a second tier friend may include a friend of a user's friend. In an embodiment, a second tier friend may include a friend of a user's contact.

Physical Distance

A physical distance may be computed between two users. The physical distance may be equal to the distance between the zip code of a first user and the zip code of a second user. In an alternate embodiment, the physical distance may be equal to the distance between the street address of the first user and the street address of the second user. Alternate or supplemental determinations may be used to determine a physical distance between two users.

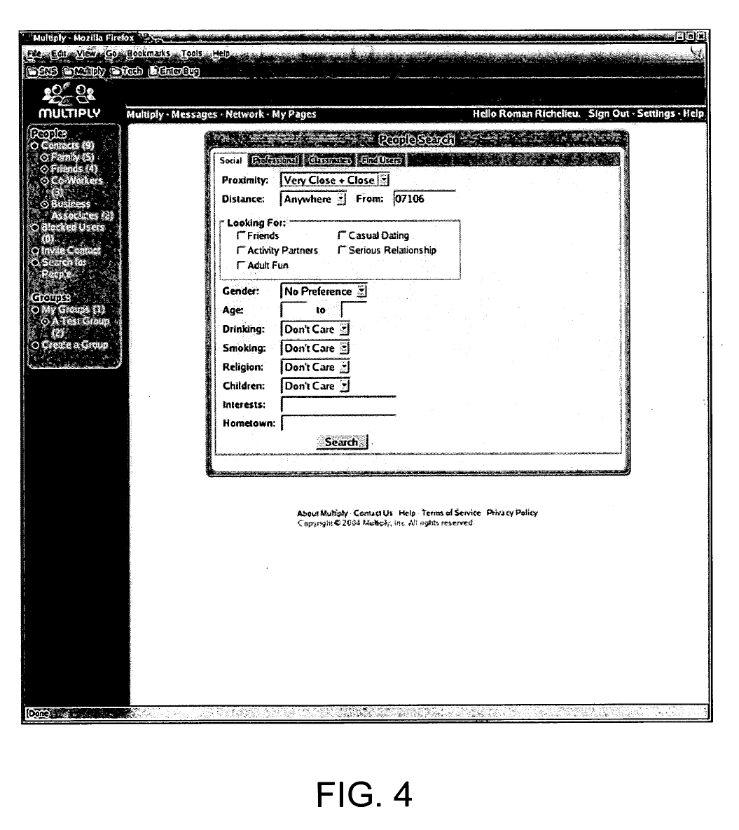

As shown in FIG. 4, the physical distance may be used as a parameter in, for example, a people search. The distance may be used to determine a subset of users in a social networking environment who list an address that is within a certain radius of, for example, an address or a zip code. Other parameters may be contemporaneously set with the physical distance to further limit the search. In an embodiment, the physical distance may be used as an access control criterion.

Social Network

In an embodiment, a user's social network may include all individuals that have a proximity index greater than the floor of the most distant range (i.e., 0.400 or “Distant” in the example above). Accordingly, individuals on the fringe of an individual's network may be within a user's social network at one time but outside of the user's social network at another time. However, the relationship between a user and his social network may remain meaningful at all times.

Access Control

Much of a user's communication or sharing may be with the user's entire social network or may be generally accessible to all members of the social networking environment. However, a user may wish to direct content to other users having user-specified relationships with the user or the user's social network. Additionally or alternately, the user may wish to direct content to groups or specified individuals. In an embodiment, the social networking environment enables a user to direct content to such groupings of individuals.

The user may either be explicit or vague regarding the users that may receive and access the content. The access control may be used to delimit access to any or all content within the social networking environment. For example, the user may wish to have personal information only available to friends and family, photos available to acquaintances, and information pertaining to an event available to friends of friends.

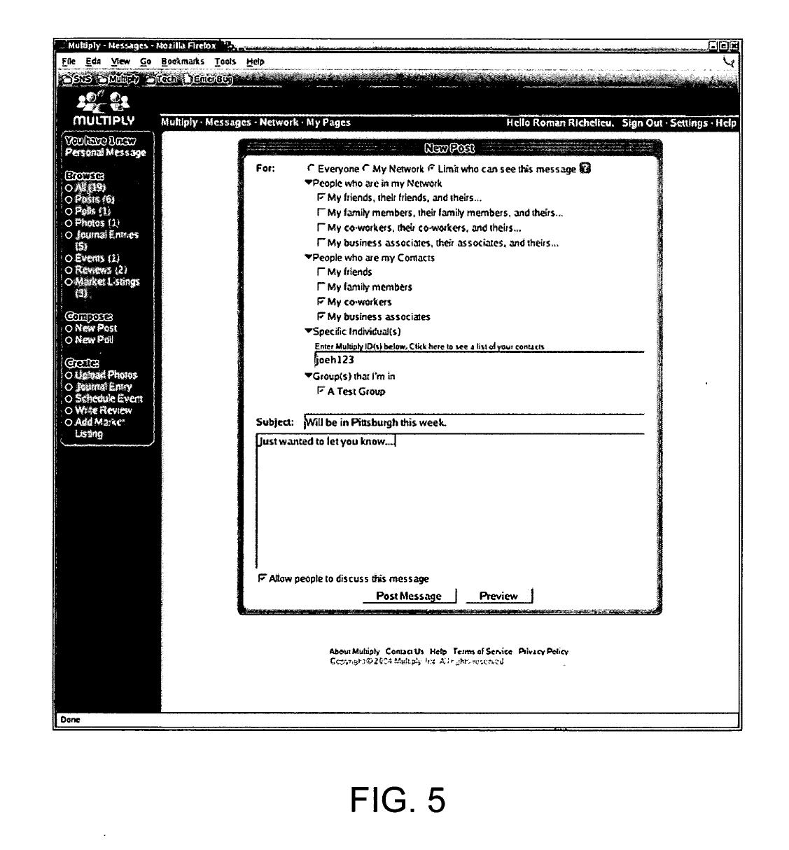

In an embodiment, the social networking environment may provide, for example, a checklist that permits the user to determine access control criteria for content, as shown in FIG. 5. The checklist may have, for example, one or more of the following values:
Everyone
My Network
My Contacts
My friends
My family members
My co-workers
My business associates
Individual(s)
Group(s)

If the user selects “Everyone,” all users, including people that are not registered as users within the social networking environment may access the given information. Thus, selecting “Everyone” may be equivalent to publishing content on a public web site. If the user selects “My Network,” as shown in FIG. 5, access to the information may include users of the social networking environment within a user's social network (as defined above). In an embodiment, a sub-checklist is displayed when a user selects “My Network.” The sub-checklist may enable the user to further delimit the users who may receive the content. For example, the social networking environment may display checkboxes for friends (including friends of friends, etc.), family members (including family members of family members, etc.), co-workers (including co-workers of co-workers, etc.) and business associates (including business associates of business associates, etc.) when a user selects the “My Network” checkbox. In an embodiment, a user's entire social network may be selected by selecting “My Network.”

If the user selects “My Contacts,” access to the information may include contacts confirmed by the user, as shown in FIG. 5. Within a list of contacts, a user may target one of, for example, four relationship groups. In an embodiment, the relationship groups may include one or more of Friends, Family, Co-Workers or Business Associates. In an embodiment, a second checklist including checkboxes for each of the relationship groups are displayed when a user selects “My Contacts” from the first checklist.

In an alternate embodiment, a user may target any relationship designator under the “My Contacts” link. Non-exclusive lists of potential relationship designators are listed above. The user may select one or more relationship designators using, for example, a menu or a checklist. In an embodiment, the relationship designators are organized under the relationship groups defined above.

As shown in FIG. 5, if the user selects “Individual(s),” the social networking environment may generate a text entry window enabling the user to enter an individual's username. In an embodiment, the social networking environment may generate a second checklist with a checkbox for each of a user's confirmed contacts (e.g., the contacts may be listed alphabetically by last name and displayed “Last Name, First Name”). Similarly, if the user selects “Group(s),” the social networking environment may generate a second text entry window and/or a checklist with a checkbox for each of a user's groups (e.g., the groups may be listed alphabetically by group name) to permit the user to designate one or more groups.

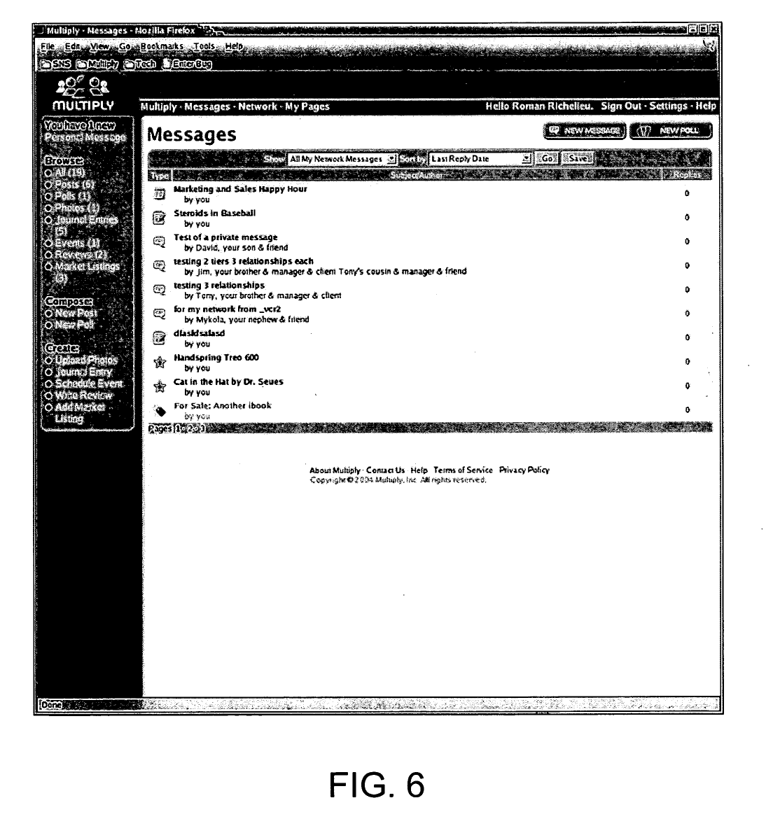

FIG. 5 depicts a checklist for assigning access control criteria used in the process of composing a post. In an embodiment, a user may also perform access control to determine the users from which content is received and displayed. For example, a user may create access control criteria limiting incoming messages to “My Contacts” to receive messages only from the user's contacts. Alternately, a user may create access control criteria limiting incoming messages to the user's network by selecting “My Network.” FIG. 6 depicts a screen shot of an exemplary content list including multi-tiered relationship designators denoting the creator of each content item according to an embodiment of the present invention.

In an alternate embodiment, the social networking environment may permit the user to define the individuals to which the content is presented more precisely. For example, the social networking environment may provide a text entry box to the user permitting free-form entry of conditions. The user may enter information such as “first tier family and second tier family and friends of first tier family” as being able to view the content. “First tier family” may include the user's contacts that are also family members. “Second tier family” may include family members of the user's family members. “Friends of first tier family” may include friends of the user's family members.

In an embodiment, the social networking environment may permit the user to display content based on the proximity index. For example, the user may desire to display content to all members of the user's social network (including those that are not first tier contacts) who are “Close” or “Very Close” to the user.

In an embodiment, a combination of designators and proximity index may be used to define access. For example, the user may designate “Very Close first tier family,” which may only permit access to first tier contacts that are family members and are Very Close to the user. Alternatively, a conjunctive use of the designators and proximity index may be used. For example, the user may designate “Very Close or first tier family,” which may permit access to first tier contacts that are family members and to members of the user's social network that are Very Close to the user. The above-listed designators are exemplary only and are not meant to be limiting. Additional combinations of the relationship designators, tier designators and proximity index may be used and are encompassed within the scope of the invention.

Content Types

The user may provide access to different types of content. For example, the user may provide access to, for example, personal information, members of the user's social network, photographs, reviews, journals, events, marketplace items, discussion topics, polls and any other type of content. In addition, the user may restrict items that the user views based on access control designations. Each of the above-listed types of content will be briefly discussed below. Although access control is discussed with respect to each of the above-listed content types, access control may be performed on unlisted content types as well.

Home Page and Personal Information

A user may access home pages within the social networking environment. A home page may correspond to a particular user or group of users (i.e., the owner). The home page may include identifying information for the owner and one or more listings created by the owner organized based on content type.

In an embodiment, a minimal amount of identifying information is displayed to every user that is not an owner of the home page. Such information may include, for example, the owner's first name, gender, city, state and zip code. The user may choose to display additional information on the home page. Such other information may be displayed generally or may be limited to specific users by access control criteria.

The user may customize their home page to display other information based on, for example, content type. Content types may include, for example, photographs, journals, calendars, reviews, marketplace item listings and other content types. The owner may add snapshot versions of the content areas to the home page. A snapshot version may include a subset of the content included in the full content listing for that content type. The owner may add a snapshot version for one or more of the content types. The user may also add other content types such as a list of favorite things, a wish list, testimonials, guest books, usage statistics and the like. For each content type, the user may specify access control criteria. In an embodiment, the access control criteria for display of a content snapshot on the owner's home page is the same as the access control criteria for such content. Access control criteria for each content type are described in more detail below.

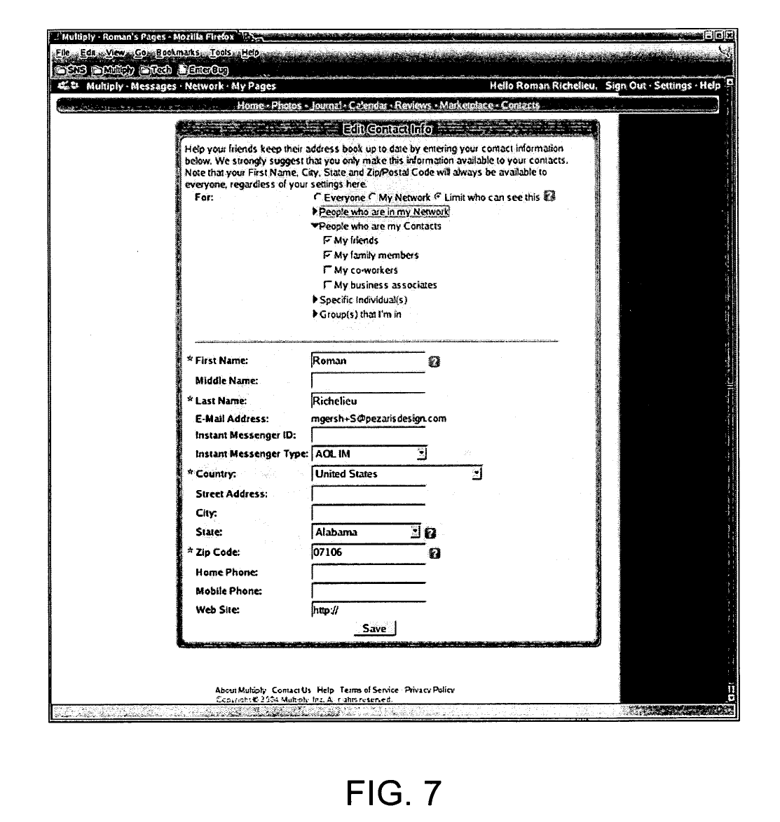

A user's personal information may be sub-divided into categories. The categories may include, for example, contact information, background information, social information, scholastic information and professional information. In an embodiment, access control may limit the amount of information displayed to other users. Different levels of access control may be applied to each category of information or to each item of information within a category. An exemplary access control list with respect to contact information according to an embodiment of the present invention is shown in FIG. 7.

In an embodiment, contact information includes, without limitation, the owner's first name, middle name, last name, e-mail address, messenger ID, messenger type (e.g., AOL IM®, ICQ, Windows Messenger®, Yahoo! Messenger®, etc.), street address, city, state, country, zip code, home phone number, work phone number, mobile phone number, fax number and personal Web site.

In an embodiment, the background information includes, without limitation, fields for an owner's gender, date of birth, interests, hometown, photograph, logo and a free-form text section describing any information the owner may wish to add to his profile. In an embodiment, the social information may include, for example, a relationship status (e.g., single, married, divorced, etc.), a “looking for” section, and information pertaining to the type of person the owner is seeking. The “looking for” section may include, for example, friends, activity partners, casual dating, serious relationship, and other categories. The information pertaining to the type of person the owner is seeking may include one or more of gender, age range, drinking habits, smoking habits, religious beliefs, whether the person wants children, a free-form text field, and other fields.

In an embodiment, the scholastic information field includes, without limitation, fields for the name of a school that the owner attended, the type of school, the city where the school is located, the state or province where the school is located, the country where the school is located, the owner's graduation year, the owner's degree or major, and one or more social organizations. The type of school may include, for example, grammar school, junior high school, senior high school, college/university, graduate school, medical school, law school, technical school or other schools. In an embodiment, the social organization field may only be displayed if the owner selects a school type of college/university. The owner may enter information for one or more schools. The information may be displayed in list form on the home page if access is provided to such information.

In an embodiment, the professional information field includes, without limitation, fields for the owner's occupation, position or title, company, company web site, industry, a “looking for” field, an overview of the owner's background, and lists of the owner's skills, previous positions held, past companies, and associations. The owner may further include a resume. The “looking for” field may denote that the owner is looking for a job, consulting or contracting position; employees or consultants; customers for products or services; information about industries, products or companies; or individuals in the owner's industry.

In an embodiment, more, fewer or different fields may be included in each of the basic, background, social, scholastic and professional information categories. In an embodiment, more, fewer or different information categories may be used.

User's Social Network

A user's social network may be sub-divided into people and group categories. The people category may include, for example, subcategories for family, friends, co-workers, business associates and blocked users. Other categories, including fewer or more categories, may be included. Blocked users may include a list of users from which content is blocked or for which access to the user's home page and content is blocked. The group category may include one entry for each group of which the user is a member. A designator may indicate the number of members of a group, the people category or a people sub-category.

For the people category, selecting a people category link may display a list of all individuals listed as contacts for the user. In addition, selecting any of the sub-category links may display a list of all individuals listed as contacts with an appropriate relationship designator for that sub-category. The list of individuals in a sub-category or in the people category may be further sub-divided based on a status for each individual. Potential statuses may include, for example, Unconfirmed, Pending and Confirmed. An Unconfirmed individual may be another user that is waiting for the user to confirm a relationship that the other user has proposed. A Pending individual may be an individual with whom the user has proposed a relationship, but who has not responded to the user's request. A Confirmed individual may be a user who has accepted a relationship proposed by the user or vice-versa. Additional, fewer or alternate status designators may be used. In an embodiment, if no individuals possess a particular status designator, that status designator is not displayed. If no contacts of any status are found for the selected category or sub-category, the social networking environment may display a message encouraging the user to make additional contacts of that type. Each table may list the individuals in that category or sub-category in a table. The table may include information pertaining to each contact including, without limitation, the contact's name, user ID, relationship, and number of contacts that the individual has. If the contact is unregistered, the name field may display an e-mail address or a messenger ID. The social networking environment may assign the user ID to the individual upon registration. The relationship may include the one or more relationship designators used to identify the relationship between the user and the listed individual. Each element of the table may provide a link to another area of the social networking environment.

Selecting any group may display a table listing all of the members of that group. The table may include one or more fields for each group member containing information pertaining to the group member, such as the group member's name, user ID, joining date and status. A group member's status may include, without limitation, pending, member or manager. A pending group member may be either a user who has been invited to join the group, but has not yet accepted the invitation, or a user who has requested membership in the group, but has not yet been accepted. A manager may be an overseer for the group. The manager may be responsible for accepting new members, managing content posted by group members and the like. A member may be any group member that is not pending and is not a manager. If the group does not have any members, a message may be displayed relaying that fact.

A user may limit access to content or personal information to particular contacts or groups. The user may define access control criteria which includes or excludes particular sub-groups of contacts or users within the social networking environment. In an embodiment, the user may globally set these settings in a Settings page, as shown in FIG. 3. The access control criteria may further limit access based on contacts of contacts or other levels of indirection.

Photographs

When a first user accesses a second user's photo page within the social networking environment, the first user may be presented with a list of the second user's photo albums. The list of photo albums may not include all photo albums produced by the second user due to access control criteria set up by the second user. For example, if the first user's only relationship designation to the second user is “co-worker,” the first user may not be able to access photo albums designated for family or friends of the second user. In an embodiment, if a user accesses his own photo page, photo album or photo, the social networking environment may permit the user to perform additional functions related to managing albums and photos, such as, for example, uploading, editing or deleting photos or photo albums.

In an embodiment, the social networking environment may present the photos in formats including, without limitation, thumbnail and details. In the thumbnail format, cover images for each photo album may be displayed to the user. A cover image may be a small version of an image in the photo album or any other image. The albums may be organized in descending or ascending order of date created or accessed, alphabetical order, any other order or randomly. Multiple cover images may be displayed on each row. Selecting a cover image may open an album to display small versions of the photos in the album. A name of the photo album may be displayed with the cover image. In groups where any member of the group can post photos, the name of the user posting the album may also be displayed with the cover image. Selecting a cover image may display the photos in a photo album.

The details display format may list photo albums by name or any other order in a table. In an embodiment, fields for the table include, without limitation, the album name, a description of the album, the number of photos in the album, the date of creation, and the number of users who have viewed the album. In an embodiment, the last column is only displayed for the owner of the photo album or, in the case of group photo albums, the group manager.

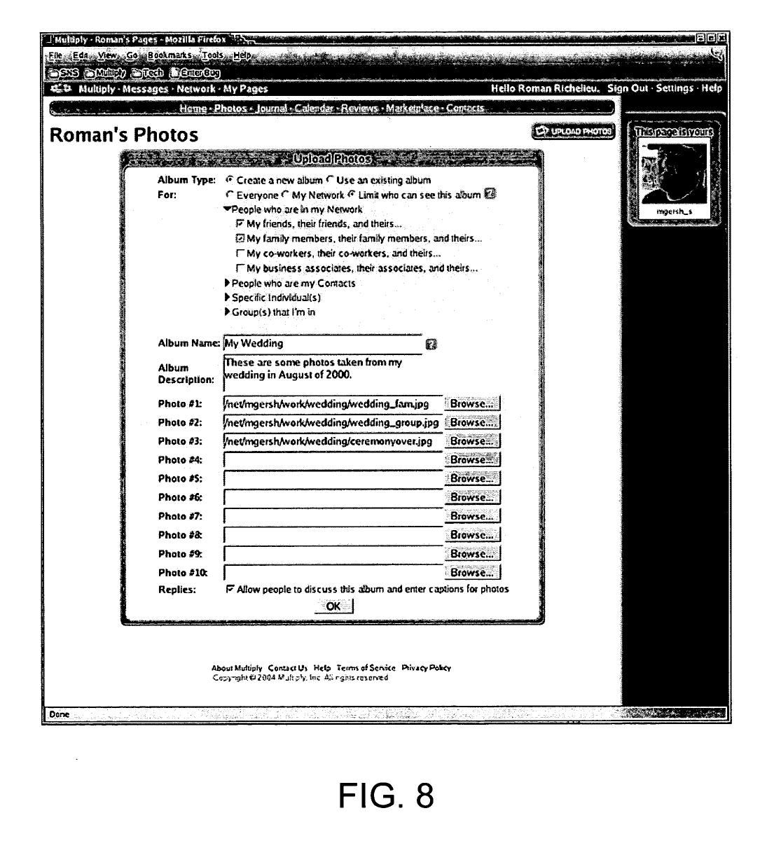

Each photo album may have a set of links associated with it that only the photo album owner may access. In an embodiment, these links include edit album, publish album, delete album and upload photo. The edit album link may allow the user to change album properties, such as, for example, the name of the photo album, the cover image of the photo album, a description of the album, access control criteria, and an ability to determine whether viewers may comment on the photo album. The access control criteria may be set, for example, by accessing a checklist, as shown in FIG. 8, or a pulldown menu to determine which users of the social networking environment may access a photo, photos or a photo album. Alternatively, a text entry box may be provided to particularly specify the users in a user's social network that may access a photo, photos or a photo album.

The publish album link may generate a notification message to all users having access to the photo album and create a thread associated with the photo album. The photo album owner or group manager and, if permitted by the owner or group manager, other users having access to the photos may post comments pertaining to the photos in the photo album in the thread. The delete album link may enable a user or group manager to delete a photo album and its associated thread.

The upload photo link may permit group managers or owners to associate photos with a photo album. In an embodiment, group members may be allowed to upload photos if permitted by the group manager. The group manager may determine users that may upload photos based on setting access control as described above.

Reviews

When a first user accesses a second user's review page within the social networking environment, the first user may be presented with a list of the second user's reviews. The list of reviews may not include all reviews created by the second user due to access control criteria set up by the second user. For example, if the first user's only relationship designation to the second user is “co-worker,” the first user may not be able to access reviews designated for family or friends of the second user. In an embodiment, if a user accesses his review page or a specific review, the social networking environment may permit the user to perform additional functions related to managing reviews, such as, for example, editing or deleting the reviews.

Reviews may be displayed, for example, in chronological or alphabetical order. In an embodiment, the category for the review, the title of the review, the rating assigned to the reviewed item and the date that the review was posted, for example, may be displayed for each review. In an embodiment, the user selects a review category from a dropdown menu. In an alternate embodiment, the user enters a review category in a text box. Review categories may include, for example, movies, books, restaurants, products, music, games and the like. If the reviewer permits comments to be added to reviews, a designation of the number of comments and a link permitting a user to add comments to a review, for example, may be associated with the review.

In an embodiment, each review has one or more links associated with it that the reviewer can access. In such an embodiment, only the reviewer may have access to these links. The links may include a link to edit a review and a link to delete a review.

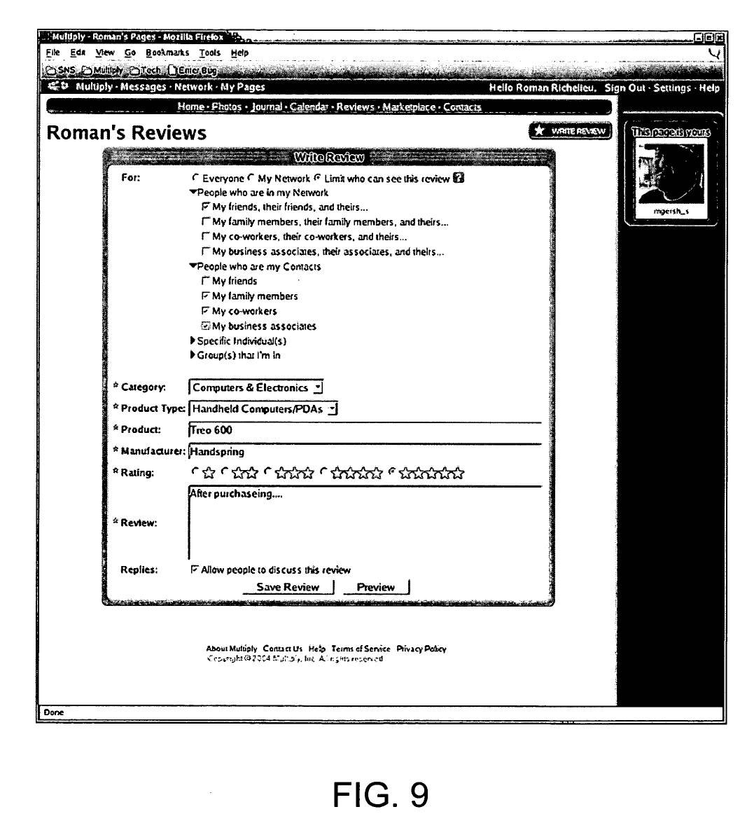

The edit review link may include one or more input fields, such as the category for the review, the name of the item being reviewed, the artist, genre, cuisine, product type, author, street address, city, state, country, zip code, manufacturer, console, the details of the view the rating and access control criteria. One or more of the above listed input fields may not be available based on the category selected by the reviewer. The access control criteria may be set, for example, by accessing a checklist, as shown in FIG. 9, or a pulldown menu to determine which users of the social networking environment may access the review. Alternatively, a text entry box may be provided to particularly specify the users in a user's social network or the social networking environment that may access the review. Once the review is complete, the owner may post the review. The delete review link may remove the review from the social networking environment.

Journals

When a first user accesses a second user's journal page within the social networking environment, the first user may be presented with entries in the second user's journals. The list of journal entries may not include all journal entries produced by the second user due to access control criteria set up by the second user. For example, if the first user's only relationship designation to the second user is “co-worker,” the first user may not be able to access journal entries designated for family or friends of the second user. In an embodiment, if a user accesses his own journal page or a specific journal entry, the social networking environment may permit the user to perform additional functions related to managing the journal and journal entries, such as, for example, editing or deleting the journal or journal entries.

Journal entries may be displayed, for example, in descending or ascending order based on the date that the entry was posted. In an embodiment, the subject of the journal entry, the author of the journal entry (in the case of group journals or newsletters), the text, photos, graphics and the like associated with the journal entry, and the date and time that the journal entry was posted, for example, may be displayed for each journal entry in the journal. The author of a journal entry may not be displayed if a user owns a journal instead of a group. If the journal owner permits comments to be added to journal entries, a designation of the number of comments and a link permitting a user to add comments to a journal entry, for example, may be associated with the journal entry.

In an embodiment, each journal entry has one or more links associated with the entry that the journal entry owner can access. In such an embodiment, only the journal owner may have access to these links. The links may include a link to edit a journal entry and a link to delete an entry.

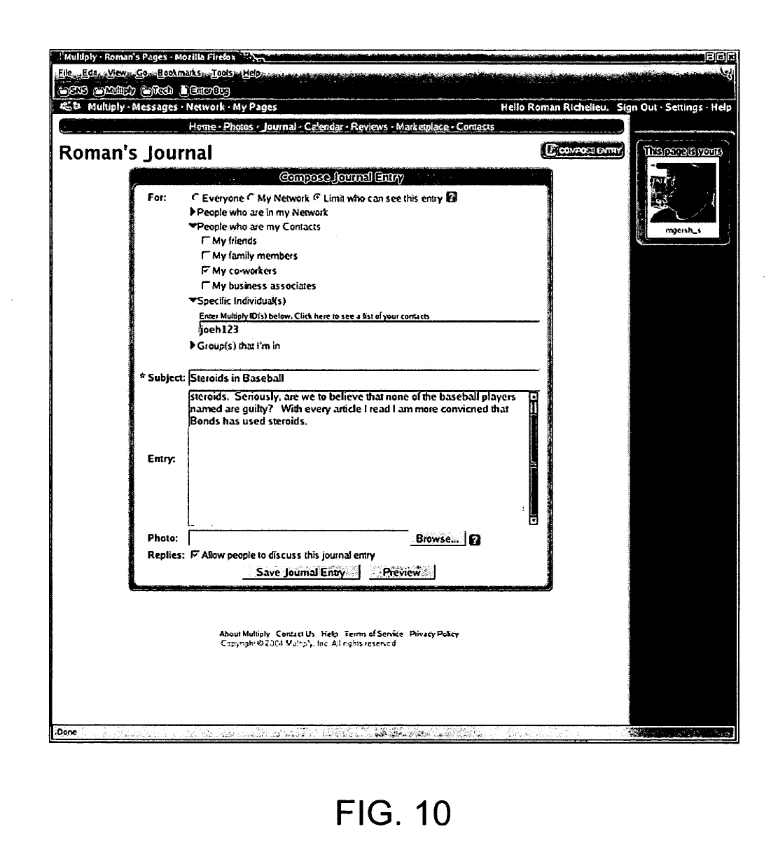

The edit journal entry link may include one or more input fields, such as the subject of the journal entry, the content for the journal entry and access control criteria. The access control criteria may be set, for example, by accessing a checklist, as shown in FIG. 10, or a pulldown menu to determine which users of the social networking environment may access the journal entry. Alternatively, a text entry box may be provided to particularly specify the users in a user's social network that may access the journal entry. Once the journal entry is complete, the owner may post the journal entry to a journal. The delete journal entry may remove the journal entry from a journal.

In an embodiment, a single user may keep multiple journals. In such an embodiment, the social networking environment may display a list of journals to a user. The journals may be organized alphabetically or in order of the most recently accessed journal.

Events

When a first user accesses a second user's calendar page within the social networking environment, the first user may be presented with events in the second user's calendar. The list of events may not include all events recorded by the second user due to access control criteria set up by the second user. For example, if the first user's only relationship designation to the second user is “co-worker,” the first user may not be able to access events designated for family or friends of the second user. In an embodiment, if a user accesses his own journal page or a specific journal entry, the social networking environment may permit the user to perform additional functions related to managing the calendar and events, such as, for example, editing or deleting the calendar or events. If the owner of the calendar permits comments to be added to an event, a designation of the number of comments and a link permitting a user to add comments to an event, for example, may be associated with each event.

Events may be displayed, for example, in chronological order. In an embodiment, the date and time of the event, the title of the event, a link to event details, the host of the event (if the event is posted on a group calendar), and the location of the event, for example, may be displayed for each event in the calendar. The host of an event may not be displayed on a user's calendar because the host is known to be the user.

In an embodiment, the social networking environment displays events in a calendar format or a list format. In an embodiment, a first user viewing an event on a second user's calendar may click on a link to automatically add the event to the first user's calendar. In an embodiment, the birthdays of a user's contacts are automatically added to the user's calendar. In an embodiment, a guest list for an event is created using access control functionality. In such an embodiment, a user on the guest list may RSVP for an upcoming event.

In an embodiment, each event has one or more links associated with the entry that the calendar owner can access. In such an embodiment, only the calendar owner may have access to these links. The links may include a link to edit an event and a link to delete an event.

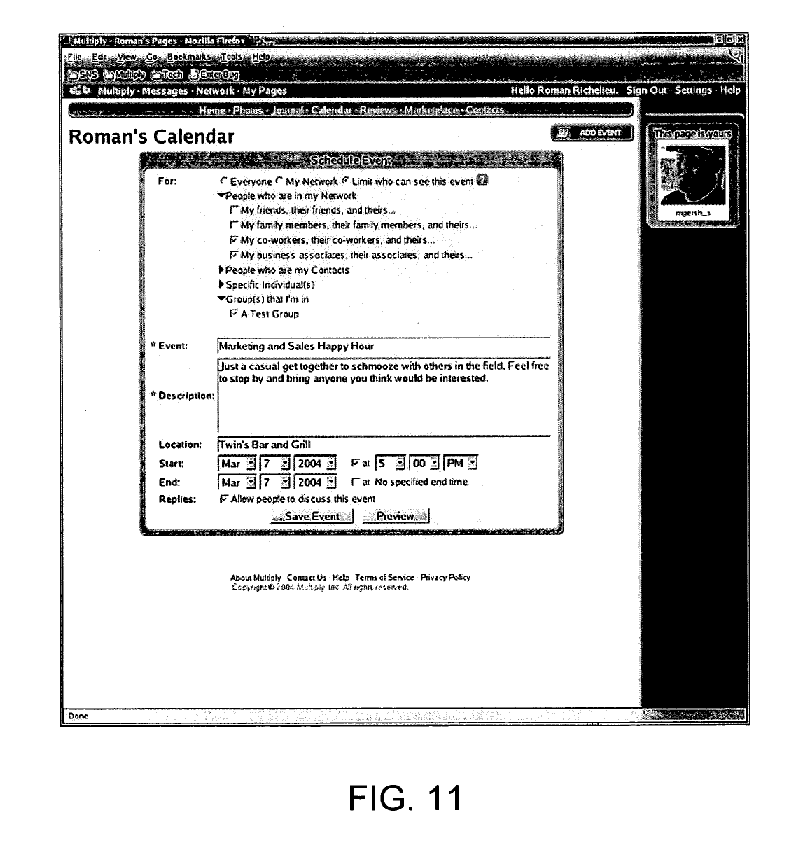

The edit event link may include one or more input fields, such as the date of the event, the time for the event, the title of the event, a description of the event, the venue for the event, a street address, a city, a state, a country, a zip code and access control criteria. The access control criteria may be set, for example, by accessing a checklist, as shown in FIG. 11, or a pulldown menu to determine which users of the social networking environment may view the event. Alternatively, a text entry box may be provided to particularly specify the users in a user's social network that may view the event. Once the event is complete, the owner may post the event to a calendar. The delete event may remove the event from a calendar.

Marketplace Items

When a first user accesses a second user's marketplace page within the social networking environment, the first user may be presented with items listed by the second user. The item listings may not include all items listed by the second user due to access control criteria set up by the second user. For example, if the first user's only relationship designation to the second user is “co-worker,” the first user may not be able to access items that the second user has listed only for family or friends of the second user. In an embodiment, if a user accesses his own marketplace page or an item listing, the social networking environment may permit the user to perform additional functions related to managing the marketplace and the item listing, such as, for example, editing or deleting one or more listings. If the owner of the marketplace permits comments to be added to an item listing, a designation of the number of comments that have been made and a link permitting a user to add comments to an item listing, for example, may be associated with each item listing.

Item listings may be displayed, for example, in chronological order by the date that the item was listed. In an embodiment, a thumbnail of a photo associated with the item listing (if any), whether the user desires to sell or buy the listed item, a category for the listing, a title of the item, a price sought (in the case that the user is selling the listed item), and the date and time that the listing was posted, for example, may be displayed for each item listing in the marketplace.

In an embodiment, the social networking environment permits a user to spotlight one or more item listings to draw attention to featured items. In such an embodiment, the user may be required to have a predetermined number of listed items before the spotlighting feature is enabled.

In an embodiment, each item listing has one or more links associated with the listing that the marketplace owner can access. In such an embodiment, only the marketplace owner may have access to these links. The links may include a link to edit an item listing and a link to delete an item listing.

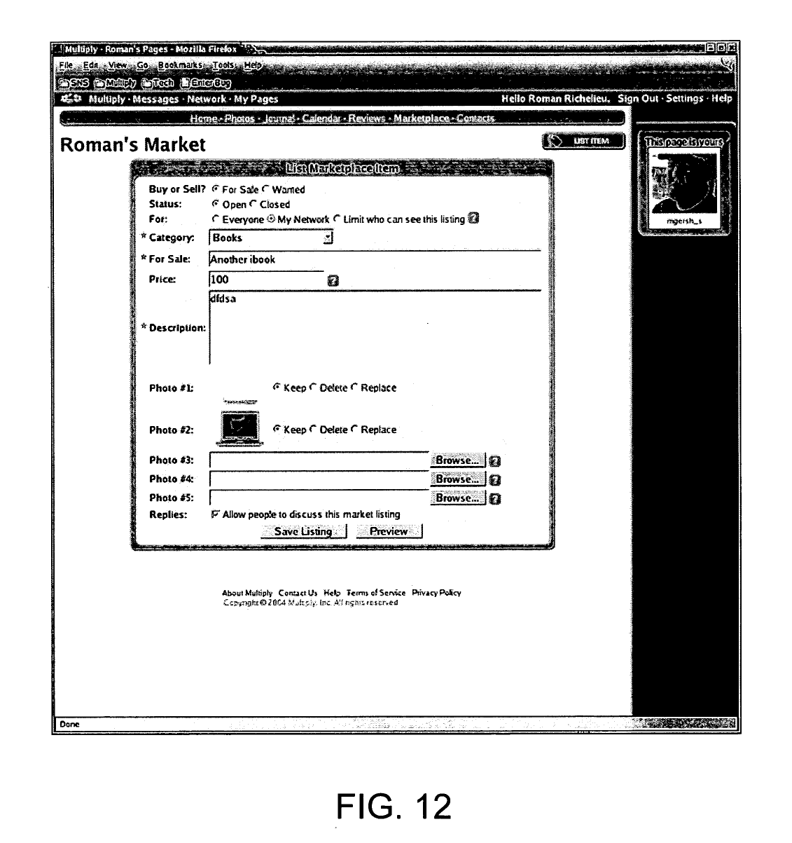

The edit item listing link may include one or more input fields, such as a buy/sell indicator, an item category, a title for the item listing, a description of the listed item, the price for the item, one or more photos depicting the listed item, and access control criteria. The access control criteria may be set, for example, by accessing a checklist, as shown in FIG. 12, or a pulldown menu to determine which users of the social networking environment may view the listed item. Alternatively, a text entry box may be provided to particularly specify the users in a user's social network that may view the item. Once the event is complete, the owner may post the item listing to the marketplace. The delete event may remove the item listing from the marketplace.

Polls

A first user may access polls created by a second user within the social networking environment. In an embodiment, only a subset of all polls created by a second user is available to the first user due to access control criteria. For example, if the first user's only relationship designation with the second user is “co-worker,” the first user may not be able to access polls designated for family or friends of the second user. In an embodiment, if a user accesses a create poll page, the social networking environment may permit the user to perform functions related to managing and creating polls, such as, for example, editing or deleting a poll. If the owner of the poll permits comments to be added to a poll, a designation of the number of comments and a link permitting a user to add comments to a poll, for example, may be associated with each poll.

Polls may be displayed in any order. In an embodiment, the social networking environment displays polls in a list format. In an embodiment, a subject, a poll question and two or more poll answers are displayed for each poll. If the poll owner permits comments to be added to a poll, a designation of the number of comments and a link permitting a user to add comments to a poll, for example, may be associated with the poll.

In an embodiment, each poll has one or more links associated with the entry that the poll owner can access. In such an embodiment, only the poll owner may have access to these links. The links may include, for example, a link to edit a poll and a link to delete a poll.

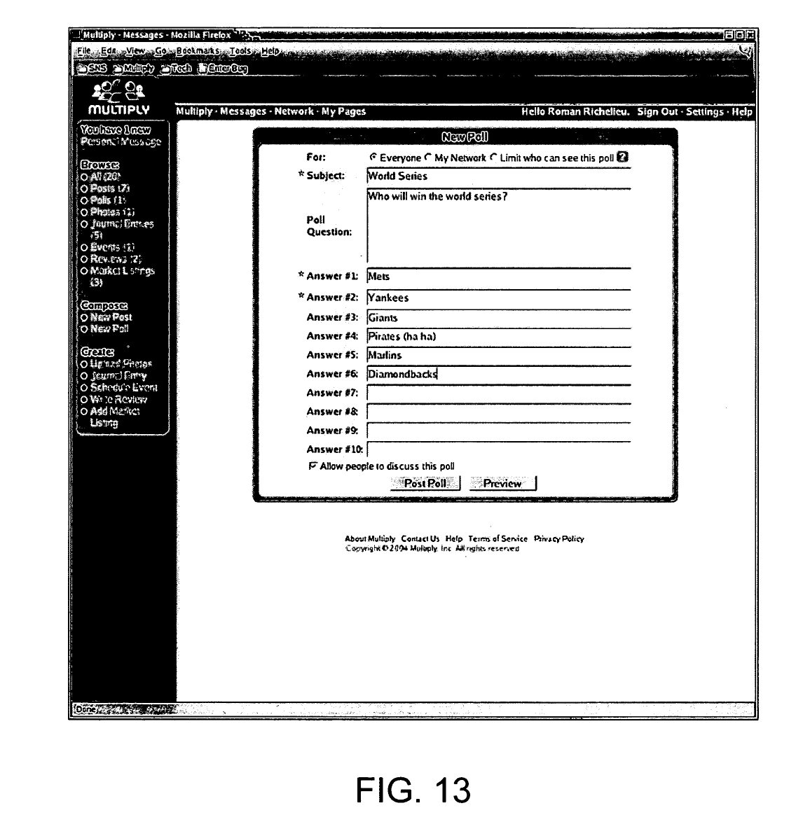

The edit poll link may include one or more input fields, such as the subject of the poll, a poll question for the poll, one or more answers for the poll and access control criteria, as shown in FIG. 13. The access control criteria may be set, for example, by accessing a checklist or a pulldown menu to determine which users of the social networking environment may view the poll. Alternatively, a text entry box may be provided to particularly specify the users in a user's social network that may view the poll. Once the owner has edited the poll, the owner may post the poll. The delete event may remove the poll from the owner's poll page.

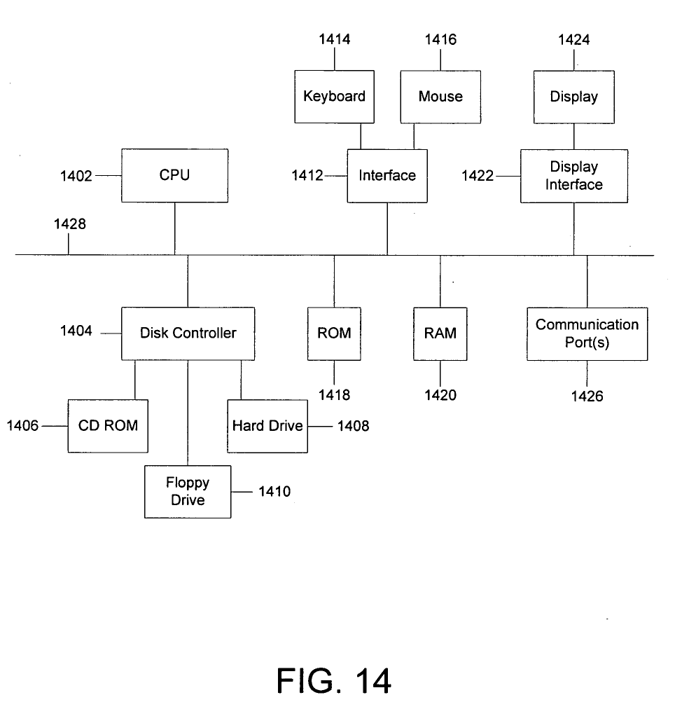

FIG. 14 is a block diagram of exemplary internal hardware that may be used to contain or implement the program instructions of a system embodiment of the present invention. Referring to FIG. 14, a bus 1428 serves as the main information highway interconnecting the other illustrated components of the hardware. CPU 1402 is the central processing unit of the system, performing calculations and logic operations required to execute a program. Read only memory (ROM) 1418 and random access memory (RAM) 1420 constitute exemplary memory devices.

A disk controller 1404 interfaces with one or more optional disk drives to the system bus 1428. These disk drives may be external or internal floppy disk drives such as 1410, CD ROM drives 1406, or external or internal hard drives 1408. As indicated previously, these various disk drives and disk controllers are optional devices.

Program instructions may be stored in the ROM 1418 and/or the RAM 1420. Optionally, program instructions may be stored on a computer readable medium such as a floppy disk or a digital disk or other recording medium, a communications signal or a carrier wave.

An optional display interface 1422 may permit information from the bus 1428 to be displayed on the display 1424 in audio, graphic or alphanumeric format. Communication with external devices may optionally occur using various communication ports 1426. An exemplary communication port 1426 may be attached to a communications network, such as the Internet or an intranet. A plurality of user computers may be attached to the communication port 1426 via the communications network to provide user access to a social networking environment.

In addition to the standard computer-type components, the hardware may also include an interface 1412 which allows for receipt of data from input devices such as a keyboard 1414 or other input device 1416 such as a remote control, pointer and/or joystick.

An embedded system may optionally be used to perform one, some or all of the operations of the present invention. Likewise, a multiprocessor system may optionally be used to perform one, some or all of the operations of the present invention.

Other criteria may be used to control access to content, a member's contact list, or personal information. For example, a user may restrict access to all users that live within a certain radius of the user's location, have the same last name or have any other item of personal information in common. Accordingly, the social networking environment may enable the user to post content to people having similar interests even if they are unknown to the individual. Such an access control may assist a user in forming a group or finding someone with a similar mindset who lives in a neighboring community.

Although the invention has been described with reference to the preferred embodiments, it will be apparent to one skilled in the art that variations and modifications are contemplated within the spirit and scope of the invention. The drawings and description of the preferred embodiments are made by way of example rather than to limit the scope of the invention, and it is intended to cover within the spirit and scope of the invention all such changes and modifications.

1. A method of controlling access to content in a social networking environment, the method comprising:
receiving, from a first user, access control criterion for content of the first user, wherein the access control criterion comprises a first relationship designator; and
if relationship information for a second user corresponds to the access control criterion, permitting the second user to access the content of the first user, wherein the relationship information comprises a second relationship designator.

2. The method of claim 1, further comprising:
if the relationship information for the second user does not correspond to the access control criterion, preventing the second user from accessing the content of the first user.

3. The method of claim 1 wherein the first relationship designator comprises one or more of the following:
a familial relationship designator;
a friendship relationship designator;
a co-worker relationship designator;
a business associate relationship designator; and
a group designator.

4. The method of claim 3 wherein the familial relationship designator comprises one or more of wife, husband, mother, father, mother-in-law, father-in-law, daughter, son, daughter-in-law, son-in-law, sister, brother, sister-in-law, brother-in-law, grandmother, grandfather, granddaughter, grandson, cousin, second cousin, aunt, uncle, nephew, niece, stepmother, stepfather, stepsister, stepbrother, stepson, stepdaughter, ex-wife, ex-husband, friend of the family, distant relative, other relative and life partner.

5. The method of claim 3 wherein the friendship relationship designator comprises one or more of fiancé, girlfriend, boyfriend, friend, roommate, neighbor, sorority sister, fraternity brother and classmate.

6. The method of claim 3 wherein the co-worker relationship designator comprises one or more of co-worker, manager, employee and business partner.

7. The method of claim 3 wherein the business associate relationship designator comprises one or more of vendor, supplier, client, contractor and business contact.

8. The method of claim 1 wherein the access control criterion further comprises a tier designator.

9. The method of claim 1 wherein the second relationship designator comprises one or more of the following:
a familial relationship designator;
a friendship relationship designator;
a co-worker relationship designator;
a business associate relationship designator; and
a group designator.

10. The method of claim 9 wherein the familial relationship designator comprises one or more of wife, husband, mother, father, mother-in-law, father-in-law, daughter, son, daughter-in-law, son-in-law, sister, brother, sister-in-law, brother-in-law, grandmother, grandfather, granddaughter, grandson, cousin, second cousin, aunt, uncle, nephew, niece, stepmother, stepfather, stepsister, stepbrother, stepson, stepdaughter, ex-wife, ex-husband, friend of the family, distant relative, other relative and life partner.

11. The method of claim 9 wherein the friendship relationship designator comprises one or more of fiancé, girlfriend, boyfriend, friend, roommate, neighbor, sorority sister, fraternity brother and classmate.

12. The method of claim 9 wherein the co-worker relationship designator comprises one or more of co-worker, manager, employee and business partner.

13. The method of claim 9 wherein the business associate relationship designator comprises one or more of vendor, supplier, client, contractor and business contact.

14. The method of claim 1 wherein the relationship information further comprises a tier designator.

15. The method of claim 1 wherein permitting the second user to access content of the first user comprises displaying the content of the first user.

16. The method of claim 1 wherein permitting the second user to access content of the first user comprises displaying a link to the content of the first user.

17. The method of claim 1 wherein preventing the second user from accessing content of the first user comprises not displaying the content of the first user when displaying a web page.

18. The method of claim 1 wherein preventing the second user from accessing content of the first user comprises not displaying a link to the content of the first user when displaying a web page.

19. A method of controlling access to content in a social networking environment, the method comprising:
receiving, from a first user, access control criterion for content directed to the first user, wherein the access control criterion comprises a first relationship designator; and
if relationship information for a second user corresponds to the access control criterion, permitting the first user to access content directed to the first user from the second user, wherein the relationship information comprises a second relationship designator.

20. The method of claim 19, further comprising:
if the relationship information for the second user does not correspond to the access control criterion, preventing the first user from accessing content directed to the first user from the second user.

21. The method of claim 19 wherein the first relationship designator comprises one or more of the following:
a familial relationship designator;
a friendship relationship designator;
a co-worker relationship designator;
a business associate relationship designator; and
a group designator.

22. The method of claim 19 wherein the access control criterion further comprises a tier designator.

23. The method of claim 19 wherein the second relationship designator comprises one or more of the following:
a familial relationship designator;
a friendship relationship designator;
a co-worker relationship designator;
a business associate relationship designator; and
a group designator.

24. The method of claim 19 wherein the relationship information further comprises a tier designator.

25. The method of claim 19 wherein permitting the second user to access content of the first user comprises displaying the content of the first user.

26. The method of claim 19 wherein permitting the second user to access content of the first user comprises displaying a link to the content of the first user.

27. The method of claim 19 wherein preventing the second user from accessing content of the first user comprises not displaying the content of the first user when displaying a web page.

28. The method of claim 19 wherein preventing the second user from accessing content of the first user comprises not displaying a link to the content of the first user when displaying a web page.

29. A method of controlling access to content in a social networking environment, the method comprising:
assigning a value to content by a first user;
generating, by a social networking environment, a proximity index denoting a strength of a relationship between the first user of the social networking environment and a second user of the social networking environment; and
if the proximity index is greater than the value, permitting the second user to access content of the first user.

30. The method of claim 29 wherein generating the proximity index comprises:
determining one or more relationships between the first user and the second user;
assigning one or more relationship values, wherein each relationship value is based on the strength of one of the one or more relationships; and
assigning the proximity index based on the one or more relationship values.

31. The method of claim 30 wherein determining one or more relationships between the first user and the second user comprises:
determining a first relationship between the first user and a third user; and
determining a second relationship between the third user and the second user.

32. The method of claim 30 wherein determining one or more relationships between the first user and the second user comprises determining a number of paths between the first user and the second user.

33. The method of claim 30 wherein the strength of a relationship is based on one or more of the following:
a number of intermediate users through which the relationship between the first user and the second user is established; and
a relationship type between each pair of users used to form the relationship between the first user and the second user.

34. The method of claim 29 wherein the proximity index comprises a designator selected from one or more of Very Close, Close, Distant, and No Contact.

35. The method of claim 29 wherein the proximity index comprises a numerical value.

36. A system for controlling access to content in a social networking environment, comprising:
a processor;
a computer-readable storage medium operably connected to the processor;
a communications network operably connected to the processor; and
a plurality of computer systems operably connected to the communications network,
wherein the computer-readable storage medium contains one or more programming instructions for performing a method of controlling access to content in a social networking environment, the method comprising:
receiving, by the processor, content from a first computer system via the communications network, wherein the content pertains to a first user,
storing the content in the computer-readable storage medium,
receiving, by the processor, access control criterion via the communications network, wherein the access control criterion pertains to the content, wherein the access control criterion comprises a first relationship designator,
storing the access control criterion in the computer-readable storage medium,
receiving, by the processor, access request information via the communications network, wherein the access request information is received from a second user using a second computer system, wherein the access request information comprises a second relationship designator, and
if the access request information corresponds to the access control criterion, transmitting the content to the second computer system.

37. The system of claim 36 wherein the access control criterion further comprises a tier designator.

38. The system of claim 36 wherein the access request information further comprises a tier designator.

39. A system for controlling access to content in a social networking environment, comprising:
a processor;
a computer-readable storage medium operably connected to the processor;
a communications network operably connected to the processor; and
a plurality of computer systems operably connected to the communications network,
wherein the computer-readable storage medium contains one or more programming instructions for performing a method of controlling access to content in a social networking environment, the method comprising:
receiving, by the processor, access control criterion from a first computer system via the communications network, wherein the access control criterion pertains to a first user,
storing the access control criterion in the computer-readable storage medium,
receiving, by the processor, content via the communications network, wherein the content is received from a second user using a second computer system,
storing the content in the computer-readable storage medium,
determining a relationship between the first user and the second user, wherein the relationship comprises a relationship designator, and
if the relationship corresponds to the access control criterion, transmitting the content to the first user at the first computer system via the communications network.

40. A system for controlling access to content in a social networking environment, comprising:
a processor;
a computer-readable storage medium operably connected to the processor;
a communications network operably connected to the processor; and
a plurality of computer systems operably connected to the communications network,
wherein the computer-readable storage medium contains one or more programming instructions for performing a method of controlling access to content in a social networking environment, the method comprising:
receiving, by the processor, content from a first computer system via the communications network, wherein the content pertains to a first user,
storing the content in the computer-readable storage medium,
receiving, by the processor, access control criterion via the communications network, wherein the access control criterion pertains to the content received from the first user, wherein the access control criterion comprises a proximity index threshold,
storing the access control information in the computer-readable storage medium,
receiving, by the processor, access request information via the communications network, wherein the access request information pertains to the content, wherein the access request information is received from a second user using a second computer system,
computing a proximity index between the first user and the second user, and
if the proximity index exceeds the proximity index threshold, transmitting the content to the second computer system via the communications network.

41. A method for searching for users within a social networking environment, the method comprising:
receiving, from a first user of a social networking environment, a search request having criteria, wherein the criteria comprise one or more of a relationship designator, personal information and a physical distance; and
transmitting, to the first user, a return list containing a designation for each of one or more second users of the social networking environment matching the criteria.

42. The method of claim 41 wherein the relationship designator comprises one or more of the following:
a familial relationship designator;
a friendship relationship designator;
a co-worker relationship designator;
a business associate relationship designator; and
a group designator.

43. The method of claim 41 wherein the personal information comprises one or more of the following:
contact information;
background information;
social information;
scholastic information; and
professional information.

44. The method of claim 43 wherein contact information comprises one or more of a first name, a middle name, a last name, an e-mail address, a messenger identifier, a messenger type, a country, a street address, a city, a state, a zip code, a home phone number, a work phone number, a mobile phone number, a facsimile number and a personal Web site.

45. The method of claim 43 wherein background information comprises a gender, a date of birth, one or more interests, a hometown, a photograph and a logo.

46. The method of claim 43 wherein social information comprises a relationship status, a sought social relationship, a sought gender, a sought age range, sought drinking habits, sought smoking habits, sought religious beliefs and a designation of whether children are desired.

47. The method of claim 43 wherein scholastic information comprises a school name, a school type, a city, a state or province, a country, a graduation year, a degree or major and a social organization, wherein the school type comprises one or more of grammar school, junior high school, senior high school, college, university, graduate school, medical school, law school, technical school and other schools.

48. The method of claim 43 wherein professional information comprises an occupation, a position, a title, a company, a company web site, an industry, a desired professional relationship, a professional background, one or more skills, one or more previously held positions, one or more past companies and one or more associations.

49. A system for searching for users within a social networking environment, comprising:
a processor;
a computer-readable storage medium operably connected to the processor;
a communications network operably connected to the processor; and
a plurality of computer systems operably connected to the communications network,
wherein the computer-readable storage medium contains one or more programming instructions for performing a method of searching for users within a social networking environment, the method comprising:
receiving, by the processor, a search request from a first user of a social networking environment using a first computer system, wherein the search request comprises criteria, wherein the criteria comprise one or more of a relationship designator, personal information and a physical distance; and
transmitting, to the first user at the first computer system via the communications network, a return list containing a designation for each of one or more second users of the social networking environment matching the criteria.
